(19) United States
(12) Patent Application Publication
(10) Pub. No.: US 2012/0267305 A1
(43) Pub. Date: Oct. 25, 2012

(54) METHOD AND DEVICE FOR BIOLOGICALLY CLEANING WASTEWATER

(75) Inventor: Marcus Hoefken, Erlangen (DE)

(73) Assignee: INVENT UMWELT-UND VERFAHRENSTECHNIK AG, Erlangen (DE)

(21) Appl. No.: 13/497,711

(22) PCT Filed: Sep. 23, 2010
(86) PCT No.: PCT/EP2010/064077

§ 371 Date: May 24, 2012

(30) Foreign Application Priority Data
Sep. 25, 2009 (DE) 10 2009 045 032.7

(51) Int. Cl. C02F 3/04; B01D 35/28

(52) U.S. Cl. 210/616; 210/151

(57) ABSTRACT

The invention relates to a method for biologically cleaning wastewater (A), comprising the following steps: providing a treatment basin (B) having a floor (1) and at least one wall (2) extending from the floor at a wall height (W), having an inlet opening (3) and having at least one outflow opening (9) in the range from 0 to a maximum of 0.5 times the wall height (W), feeding the wastewater (A) through the inlet opening (3) into the treatment basin (B), bringing the wastewater (A) into contact with microorganisms seeded in loose growth bodies (12) received in the treatment basin (B), and discharging the wastewater (A) at least partially cleaned by the action of the microorganisms from the treatment basin (B) through the outflow opening (9), wherein the growth bodies (12) are retained in the treatment basin (B).

The invention relates to a method and to a device for biologically cleaning wastewater.

It is known from DE 40 19 577 A1 to bring wastewater in contact with microorganisms in a treatment basin. Harmful substances present in the wastewater are eliminated by the action of the microorganisms. So as to generate as large a surface as possible, the microorganisms are colonized on loose biofilm substrate bodies floating in the wastewater. Such biofilm substrate bodies can be produced from plastic material, for example, and have a diameter between 0.5 and 5.0 cm. The specific weight thereof generally ranges around 0.9 g/m³ and consequently experiences buoyancy in the wastewater. A suspension formed of the biofilm substrate bodies and the wastewater is usually stirred by means of an agitator.

So as to achieve the best possible cleaning performance, several such treatment basins can be arranged consecutively. The wastewater is brought in contact with the respective other microorganisms in each of the treatment basins.

In order to prevent the biofilm substrate bodies to be flushed out of a treatment basin, a drainage or overflow opening comprising a screen is provided. According to the prior art, the problem of a large amount of biofilm substrate bodies accumulating in front of the screen arises, whereby the wastewater is prevented from flowing off through the outflow opening.

So as to counteract this problem, a propeller agitator is provided in addition to the agitator at the overflow opening. This generates a flow that moves the biofilm substrate bodies away from the screen.

Such a propeller agitator is complex to provide, notably in the case of a treatment basin having several outflow openings. The operation thereof requires high energy expenditure and maintenance and is therefore expensive.

The object of the invention is to eliminate the disadvantages of the prior art. In particular a method and a device are to be provided which allow the biological cleaning of wastewater with reduced complexity and expenditure. According to further object of the invention, additionally energy is to be saved with the method and the device.

This object is achieved by the characteristics of claims 1 and 5. Advantageous embodiments of the invention will be apparent from the features of claims 2 to 4 and 6 to 14.

According to the invention, a method comprising the following is proposed for biologically cleaning wastewater:

providing a treatment basin comprising a bottom and at least one wall extending therefrom with a wall height, an inlet opening, and at least one outflow opening provided in a region between 0 and no more than 0.5 times the wall height;

supplying the wastewater through the inlet opening into the treatment basin; bringing the wastewater in contact with microorganisms colonizing loose biofilm substrate bodies that are accommodated in the treatment basin;

generating a flow by means of a vertical agitator comprising a hyperboloid agitator body, so that a suspension formed of the biofilm substrate bodies and the wastewater is moved toward the bottom of the treatment basin in the region of a shaft of the vertical agitator and is moved toward a surface of the suspension in the region of the wall of the treatment basin; and

discharging the wastewater, which has been at least partially cleaned by the action of the microorganisms, from the treatment basin through the outflow opening, wherein the biofilm substrate bodies are retained in the treatment basin by means of a screen provided in the region of the outflow opening.

Because, according to the invention, a hyperboloid agitator body generates a flow that is directed toward the surface of the suspension in the region of the wall of the treatment basin, the buoyancy bodies are moved away from the outflow opening provided in a bottom-side lower half of the treatment basin. Undesirable deposition of biofilm substrate bodies in the region of the outflow opening can thus be easily and cost-effectively avoided and, at the same time, the wastewater can be stirred. In particular, the provision of propeller agitators for keeping the outflow openings clear can be dispensed with.

To the extent that within the meaning of the present invention the outflow opening is located in the region of 0 times the wall height, it therefore does not extend into the wall. In this case, the outflow opening is located in the bottom of the treatment basin. To the extent that the outflow opening is located in the region of 0 to 0.5 times the wall height, it can extend in the bottom and in the wall. It can also be provided only in the wall and extend to the bottom.

The treatment basin can be a cylindrical treatment basin. In this case, the treatment basin is surrounded by a single peripheral wall. However, it is also possible for the treatment basin to have a rectangular shape. In this case, the treatment basin is delimited by several walls. If several walls delimit the treatment basin and the several walls have differing heights, the term “wall height” shall be understood to mean an average wall height.

According to the invention, the biofilm substrate bodies are retained in the treatment basin by means of a screen provided in the region of the outflow opening. The screen can have a larger inflow surface area than the outflow opening. This means that the screen can also span the outflow opening beyond the edge region thereof. It may also be arranged at a distance from the outflow opening. In this case, the screen will extend on the peripheral edge to the bottom or the wall on which the outflow opening is provided.

Within the meaning of the present invention, a “vertical agitator” shall be understood to mean an agitator in which the hyperboloid agitator body is arranged on a substantially vertically oriented shaft. The shaft can be driven by means of a motor. The motor can be a submersible motor. However, it is also possible for the motor to be arranged above a surface of the wastewater on a tower-like frame which is supported on the bottom of the treatment basin.

According to the invention, the action of the hyperboloid agitator body applies a flow to the suspension, the flow being directed toward the bottom of the treatment basin approximately in the region of the shaft of the vertical agitator and it being directed toward a surface of the suspension in the region of the wall of the basin. Moreover, the flow can rotate in the rotational direction of the hyperboloid agitator body about the axis thereof.

The flow generated by the vertical agitator is directed upward, notably in the bottom-side edge region of the treatment basin. It thus counteracts a deposition of biofilm substrate bodies in the region of an outflow opening provided there.

The movement of the biofilm substrate bodies in the direction of the surface of the suspension as a result of the flow can be further supported by using biofilm substrate bodies having a specific weight that is lower than the specific weight of the wastewater. In this case, the biofilm substrate bodies experience a buoyancy force, which acts in addition to the upwardly directed flow in the region of the walls. In this way, a deposition of biofilm substrate bodies in the region of an outflow opening that is provided in the lower half, and preferably in a lower third, of the treatment basin can be prevented particularly effectively.

According to a further embodiment of the invention, the wastewater is discharged through at least one outflow opening which is provided in the bottom of the treatment basin and is preferably located in the vicinity of a wall. It is also possible for the wastewater to be discharged through at least one outflow opening which is provided in the vicinity of the bottom and is preferably located in the vicinity of a wall. It has been found to be particularly advantageous to provide the outflow opening in the region of a corner of the bottom when the treatment basin has a rectangular shape. It can then be provided in the bottom and/or in a wall in the region of the corner of the bottom.

According to the invention, moreover a device for biologically cleaning wastewater is proposed, comprising: a treatment basin having a bottom and at least one wall extending therefrom with a wall height, an inlet opening, and at least one outflow opening, which is provided in a region from 0 to no more than 0.5 times the wall height and is equipped with a screen for retaining biofilm substrate bodies, loose biofilm substrate bodies accommodated in the treatment basin, and a vertical agitator comprising a hyperboloid agitator body for generating a flow in a suspension which is formed of the biofilm substrate bodies and the wastewater and which is directed toward the bottom of the treatment basin in the region of a shaft of the vertical agitator and is directed toward a surface of the suspension in the region of the wall of the treatment basin. In this way, excess accumulation of biofilm substrate bodies in the region of the screen can be easily and cost-effectively avoided and, at the same time, the suspension can be stirred.

According to the invention, the device comprises loose biofilm substrate bodies accommodated in the treatment basin. These can be extruded plastic bodies. The specific weight of such biofilm substrate bodies is advantageously lower than the specific weight of the wastewater. Biofilm substrate bodies having a specific weight of less than 1 g/cm³ experience a buoyancy force in the wastewater. Such a buoyancy force counteracts the clogging of a screen, which covers an outflow opening provided in a lower half of the treatment basin or closes the same with respect to the passage of the biofilm substrate bodies.

The vertical agitator comprises a hyperboloid agitator body. In this way, a flow can be applied in a particularly efficient manner.

It has been found to be particularly advantageous for the outflow openings to be provided in a region of 0 to 0.3 times, and preferably 0 to 0.2 times, the wall height. This means that the at least one outflow opening is advantageously provided in the bottom and/or in the vicinity of the bottom on the wall.

The inlet opening can be provided in a region 0.5 to 1.0 times the wall height. This means that the inlet opening is advantageously arranged in an upper half of the treatment basin. It can notably be provided in a maximum or substantially maximum distance from the outflow opening. In this way, a particularly high residence time of the wastewater that is supplied through the inlet opening in the treatment basin can be achieved.

According to a further advantageous embodiment, several treatment basins can be arranged consecutively. In this case, the inlet opening of a first treatment basin provided upstream is advantageously provided in the region of 0.5 to 1.0 times the wall height. In contrast, at least one further inlet opening of a further treatment basin located downstream of the first treatment basin is designed similarly to the outflow opening. This means that the further inlet opening is provided in a region of 0 to no more than 0.5 times the wall height of the further treatment basin. It can in particular also be provided in the bottom of the further treatment basin. In this case, a horizontal plate may be provided above such a further inlet opening, the horizontal plate deflecting a flow directed through the further inlet opening and guiding the same substantially along the bottom of the further inlet basin. The further inlet opening, however, can also be provided in a lower section of the wall, and more particularly in the vicinity of the bottom—like the outflow opening in the first treatment basin.

The outflow opening can be provided in the bottom, and more preferably in the vicinity of the wall, and/or in the wall in the vicinity of the bottom. It is also possible to provide several such outflow openings. It has been found to be particularly advantageous to provide the outflow opening in the region of a corner of the bottom when the treatment basin has a rectangular shape. A screen can be provided in the region of the outflow opening so as to retain the biofilm substrate bodies. The screen can extend beyond an edge of the outflow opening.

The biofilm substrate bodies can be extruded plastic bodies. The specific weight of such biofilm substrate bodies advantageously is lower than the specific weight of the wastewater. Biofilm substrate bodies having a specific weight of less than 1 g/cm³ experience a buoyancy force in the wastewater. Such a buoyancy force counteracts the clogging of a screen, which covers an outflow opening provided in a lower half of the treatment basin or closes the same with respect to the passage of the biofilm substrate bodies.

According to a further advantageous embodiment, 10 to 65%, and preferably 20 to 50%, of a volume of the treatment basin is filled with biofilm substrate bodies. Particularly efficient cleaning performance can thus be achieved.

According to a further advantageous embodiment of the invention, the vertical agitator is supported on the bottom of the treatment basin. The vertical agitator is advantageously arranged in the center of the treatment basin. The vertical agitator allows a suspension formed of the biofilm substrate bodies and the wastewater to be continuously stirred.

According to a further advantageous embodiment, an aeration unit is accommodated in the treatment basin. This allows the cleaning performance of the device to be further improved.

Exemplary embodiments of the invention will be described in more detail hereafter based on the drawings. In the drawings:

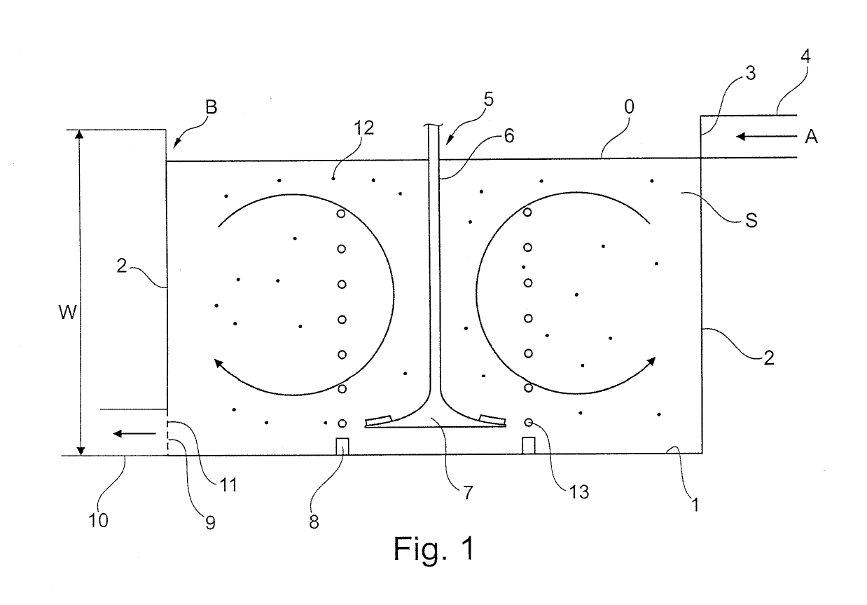

FIG. 1 is a schematic cross-sectional view of a first device;

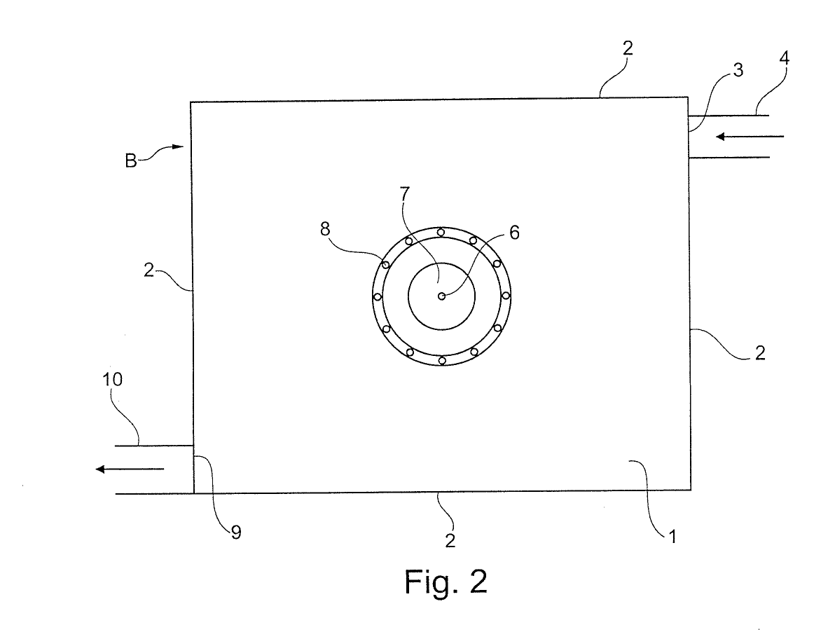

FIG. 2 is a top view according to FIG. 1;

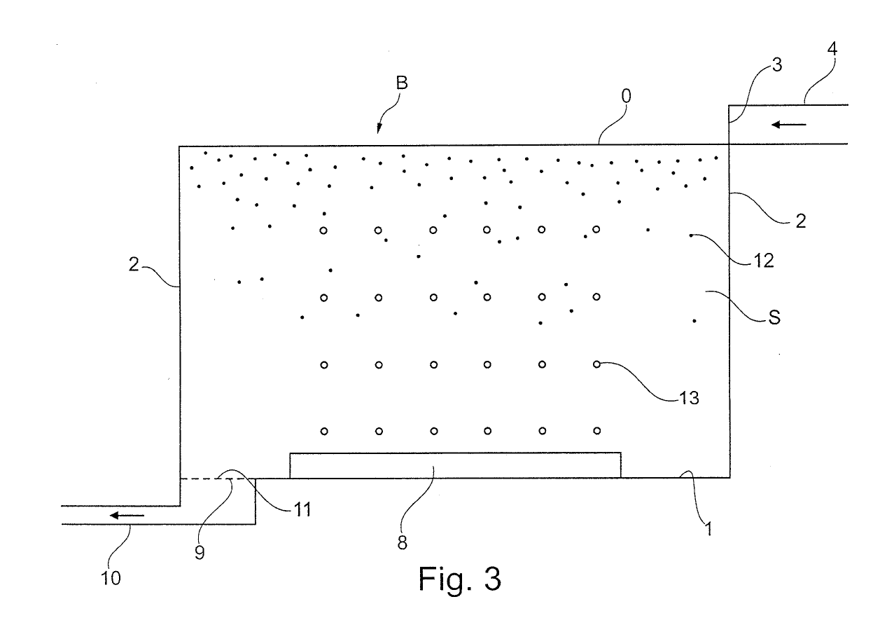

FIG. 3 is a schematic cross-sectional view of a second device;

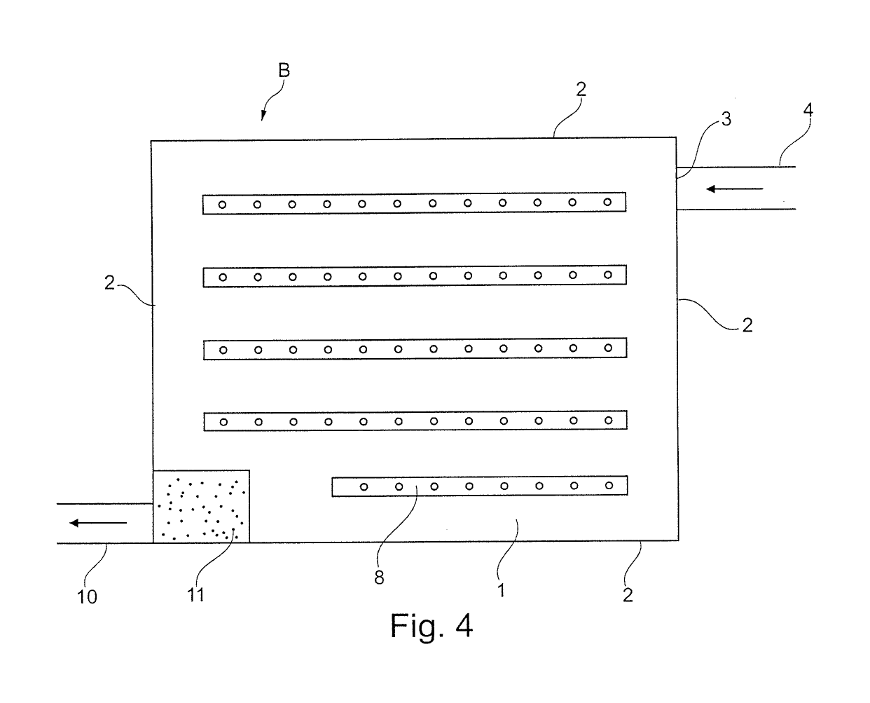

FIG. 4 is a top view according to FIG. 3; and

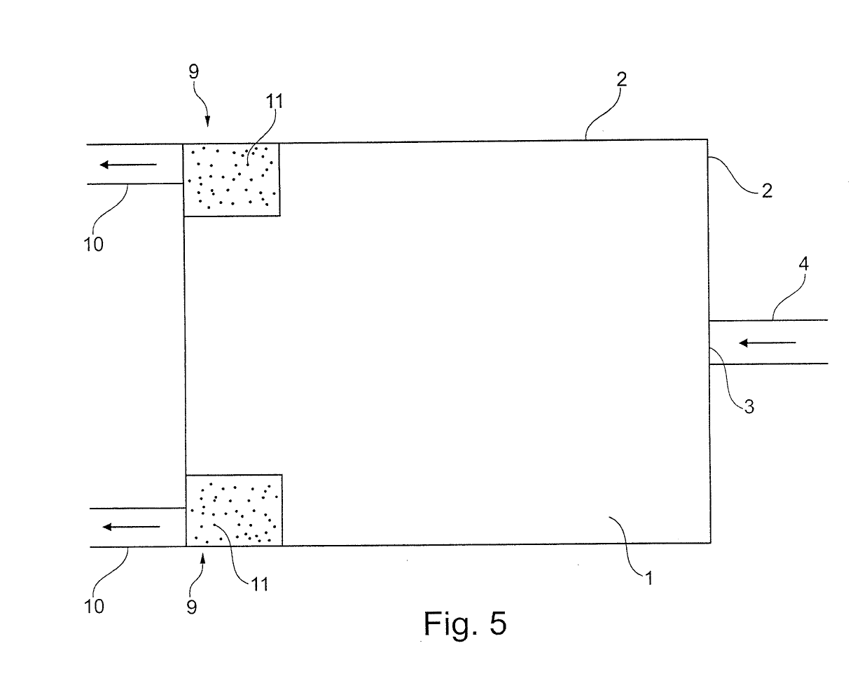

FIG. 5 is a top view according to a third device.

In the first device shown in FIGS. 1 and 2, a treatment basin denoted in the overall by reference sign B has a rectangular shape. Four walls 2 with a wall height W extend from the bottom 1. The treatment basin B is made of concrete, for example. Reference numeral 3 denotes an inlet opening of an inlet channel 4. The inlet opening 3 is located on the upper edge of one of the walls 2. A vertical agitator, which is denoted in the overall by reference numeral 5, comprises a shaft 6, at the end of which a hyperboloid agitator body 7 is arranged. An aeration unit 8 is supported on the bottom 1, the unit having a ring-shaped design and being arranged in the vicinity of the hyperboloid agitator body 7. The aeration unit 8 can also be provided below the hyperboloid agitator body 7. An outflow opening 9 of an outflow channel 10 is arranged on one of the walls 2. The outflow opening 9 is provided with a screen 11. The mesh of the screen 11 is smaller than a diameter of biofilm substrate bodies denoted by reference numeral 12. The outlet opening 9 is located in a bottom-side lower half of the treatment basin B. It is located in particular in the region of 0.1 to 0.2 times the wall height W.

Reference numeral O denotes a surface of a suspension S formed of the biofilm substrate bodies 12 and the wastewater A.

As is apparent in particular from FIG. 2, the inlet opening 3 and the outflow opening 9 can be arranged such that the distance thereof inside the treatment basin B is approximately at a maximum.

The function of the device is as follows:

Wastewater A is supplied to the treatment basin B through the inlet channel 4. In the treatment basin B, the wastewater A comes in contact with microorganisms (not shown here) colonizing the biofilm substrate bodies 12. The action of the vertical agitator 5 applies a current to the suspension S, as indicated by the arrows in FIG. 1. The flow is directed toward the bottom 1 in the region of the shaft 6. In contrast, the flow is directed toward the surface O in the region of the walls 2. As a result of the flow, the biofilm substrate bodies 12 are transported away from the outflow opening 9 in the direction of the surface O. The movement of the biofilm substrate bodies 12 which is directed toward the surface O can be supported by producing the bodies from a material having a specific weight that is lower than the specific weight of the wastewater, for example less than 1.0 g/cm³. As a result, the biofilm substrate bodies 12 experience a buoyancy force, which moves them additionally in the direction of the surface O.

The suspension S can additionally be aerated by means of the aeration units 8. Gas bubbles 13 rising from the aeration unit 8 in the direction of the surface O lend the biofilm substrate bodies 12 an additional buoyancy force. This buoyancy force can be supported by an adsorption of gas bubbles 13 on the biofilm substrate bodies 12 and/or by an upward flow caused by the ascent of the gas bubbles. Advantageously one of the aeration units 8 is arranged in the vicinity of the screen 11 (not shown here). In this way, the biofilm substrate bodies 12 do not clog the screen 11.

In the second device shown in FIGS. 3 and 4, the treatment basin B merely accommodates an aeration unit 8. Here, the outflow opening 9 is located in the bottom 1, and more specifically in the region of a corner of the bottom 1. The inlet opening 3 is arranged diagonally opposed at the upper edge of the wall 2. Reference numeral 13 denotes gas bubbles which are given off from the aeration unit 8 to the suspension S. The gas bubbles 13 support a movement of the biofilm substrate bodies 12 which is directed toward the surface O. As a result, the screen 11 spanning the outflow opening 9 is kept substantially free of biofilm substrate bodies 9.

FIG. 5 shows a top view of a third device. A respective outflow opening 9 of an outflow channel 10 is provided in two adjoining corners in the bottom 1, each opening being covered by a screen 11. An inlet opening 3 is arranged here opposite the outflow openings 9 in the center of the wall 2.

The one or more outflow openings 9 can, of course, also be arranged differently. For example, they can extend along a bottom-side edge in the bottom 1 and/or in the wall 2.

The screen 11 can also be designed as at least one elongated slot, the slot width of which is smaller than a diameter of the biofilm substrate bodies 12. Such a slot can be provided in the wall 2 or in the bottom 1.

A drainage line can also be supported on the bottom 1 and thus form the screen 11. Such a drainage line comprises apertures in the manner of a screen, the diameters of which are smaller than a diameter of the biofilm substrate bodies 12. The drainage line can be connected to the outflow channel 10. The drainage line can, for example, run along the bottom-side edges in an annular shape.

At least one further treatment basin (not shown here) can be provided downstream of the treatment basin B shown in FIGS. 1 to 5. To this end it is advantageous for the outflow channel 10 of the treatment basin to lead directly into a further inlet opening (not shown here) in the downstream further treatment basin. In this case, similarly to the outflow opening 9, the further inlet opening in the further treatment basin is thus arranged either in a further bottom of the further treatment basin and/or in a lower section of a further wall of the further treatment basin.

### LIST OF REFERENCE NUMERALS

1 Bottom
2 Wall
3 Inlet opening
4 Inlet channel
5 Vertical agitator
6 Shaft
7 Hyperboloid agitator body
8 Aeration unit
9 Outflow opening
10 Outflow channel
11 Screen
12 Biofilm substrate body
13 Gas bubbles
A Wastewater
B Treatment basin
O Surface
S Suspension
W Wall height

1-14. (canceled)

15. A method for biologically cleaning wastewater (A), comprising the following steps:
providing a treatment basin (B) comprising a bottom (1) and at least one wall (2) extending therefrom with a wall height (W), an inlet opening (3), and at least one outflow opening (9) that is provided in a region between 0 and no more than 0.2 times the wall height, wherein the inlet opening (3) and the outflow opening (9) are arranged such that the distance thereof inside the treatment basin (B) is approximately at the maximum;
supplying the wastewater (A) through the inlet opening (3) into the treatment basin (B);
bringing the wastewater (A) in contact with microorganisms colonizing loose biofilm substrate bodies (12) accommodated in the treatment basin (B);
generating a flow by means of a vertical agitator comprising a hyperboloid agitator body, so that a suspension (S) that is formed of the biofilm substrate bodies (12) and the wastewater (A) is moved toward the bottom (1) of the treatment basin (B) in the region of a shaft (6) of the vertical agitator (5) and is moved toward a surface (O) of the suspension (S) in the region of the wall (2) of the treatment basin (B); and
discharging the wastewater (A), which has been at least partially cleaned by the action of the microorganisms, from the treatment basin (B) through the outflow opening (9), wherein the biofilm substrate bodies (12) are retained in the treatment basin (B) by means of a screen (11) provided in the region of the outflow opening (9).

16. The method according to claim 15, wherein the wastewater (A) is discharged through at least one outflow opening (9) provided in the bottom (1) of the treatment basin (B), the outflow opening being preferably arranged in the vicinity of a wall (2).

17. A method according to claim 15, wherein the wastewater (A) is discharged through at least one outflow opening (9) provided in a wall (2) of the treatment basin (B), the outflow opening being preferably arranged in the vicinity of the bottom (1).

18. A device for biologically cleaning wastewater, comprising:
a treatment basin (B) comprising a bottom (1) and at least one wall (2) extending therefrom with a wall height (W), an inlet opening (3), and at least one outflow opening (9) which is provided in a region from 0 to no more than 0.2 times the wall height (W) and is equipped with a screen for retaining biofilm substrate bodies (12), wherein the inlet opening (3) and the outflow opening (9) are arranged such that the distance thereof inside the treatment basin (B) is approximately at the maximum;
loose biofilm substrate bodies (12) accommodated in the treatment basin (B); and
a vertical agitator (5) comprising a hyperboloid agitator body for generating a flow in a suspension (S) formed of the biofilm substrate bodies (12) and the wastewater (A), the flow being directed toward the bottom (1) of the treatment basin (B) in the region of a shaft (6) of the vertical agitator (5) and being directed toward a surface (O) of the suspension (S) in the region of the wall (2) of the treatment basin (B).

19. The device according to claim 18, wherein the outflow opening (9) is provided in the bottom (1), preferably in the vicinity of the wall (2).

20. The device according to claim 18, wherein the outflow opening (9) is arranged in the wall (2), preferably in the vicinity of the bottom (1).

21. A device according to claim 18, wherein the biofilm substrate bodies (12) are extruded plastic elements.

22. A device according to claim 18, wherein 10 to 65%, and preferably 20 to 50%, of a volume of the treatment basin (B) is filled with biofilm substrate bodies (12).

23. A device according to claims 18, wherein the vertical agitator (5) is supported on the bottom (1) of the treatment basin (B).

24. A device according to claim 18, wherein an aeration unit (8) is accommodated in the treatment basin (B).
